(19) United States
(12) Patent Application Publication
(10) Pub. No.: US 2014/0266083 A1
(43) Pub. Date: Sep. 18, 2014

(54) Energy-Saving Device with a Voltage-Regulating Function

(71) Applicants: Sheng-Lian Lin, Taoyuan City (TW); Yu-Ying Lin, Taoyuan City (TW); Tung-Yi Lin, Taoyuan County (TW)

(72) Inventors: Sheng-Lian Lin, Taoyuan City (TW); Yu-Ying Lin, Taoyuan City (TW); Tung-Yi Lin, Taoyuan County (TW)

(21) Appl. No.: 13/798,387

(22) Filed: Mar. 13, 2013

(51) Int. Cl. G05F 3/04

(52) U.S. Cl. CPC G05F 3/04
USPC 323/208

(57) ABSTRACT

An energy-saving device is electrically connected between an output terminal of an electric power and an input terminal of a load and includes a current dividing unit connected with the load in parallel, and a voltage dividing unit connected with the load serially. The current dividing unit has an input terminal electrically coupled to an output terminal of the load and an output terminal electrically coupled to the input terminal of the load. The voltage dividing unit has an input terminal electrically coupled to the output terminal of the electric power and an output terminal electrically coupled to the input terminal of the load. Thus, the voltage dividing unit drops the voltage of the load applied by the electric power, and the current dividing unit increases the current flowing into the load, so that the energy-saving device achieves an energy-saving purpose.

### BACKGROUND OF THE INVENTION

1. Field of the Invention

The present invention relates to an electric device and, more particularly, to an energy-saving device.

2. Description of the Related Art

Usually, when a power company supplies an electric power to a user terminal, the voltage is increased with a relative ratio during delivery of the electric power, so as to compensate the voltage drop at the user terminal, and to reduce the loss in the delivery line. However, the higher voltage supplied by the power company will easily cause damage to the electric appliance of the user terminal, thereby shortening the lifetime of the electric appliance, and wasting the electrical energy. For example, when a load (such as an electric bulb) is used, the rating voltage of the load is equal to 110V, and the rating power of the load is equal to 100 W. At this time, the resistance of the load is equal to 121Ω (110²/100=121) under the formula of R=V²/P, and the electric current of the load is equal to 0.91 A (100/110=0.91) under the formula of I=P/V. When the voltage supplied by the power company is increased by ten percent (10%), the voltage of the load is equal to 121V (110+110×10%=121). At this time, the power of the load is equal to 121 W (121²/121=121) under the formula of P=V²/R, and the electric current of the load is equal to 1 A (121/121=1) under the formula of I=P/V. Thus, when the voltage of the load is increased to 121V, the electric current of the load is increased by 0.09 A (1-0.91=0.09), and the power of the load is increased by 21 W (121−100=21). In such a manner, when the voltage of the load is increased, the electric current of the load is increased so that the electrical energy is wasted, and the power of the load is increased to increase the burden of the load so that the lifetime of the load is shortened. Thus, when the voltage supplied by the power company is increased, increase of the voltage will waste the electrical energy and will do damage to the load or equipment.

### BRIEF SUMMARY OF THE INVENTION

In accordance with the present invention, there is provided an energy-saving device electrically connected between an output terminal of an electric power and an input terminal of a load, comprising a current dividing unit connected with the load in parallel, and a voltage dividing unit connected with the load serially. The current dividing unit has an input terminal electrically coupled to an output terminal of the load and an output terminal electrically coupled to the input terminal of the load. The voltage dividing unit has an input terminal electrically coupled to the output terminal of the electric power and an output terminal electrically coupled to the input terminal of the load.

Preferably, the electric power is an alternating-current input power supply.

Preferably, the current dividing unit is a passive component which is an inductor or a capacitor.

Preferably, the voltage dividing unit is a passive component which is an inductor or a capacitor.

Alternatively, the current dividing unit is an active component which is a transistor.

Alternatively, the voltage dividing unit is an active component which is a transistor.

Alternatively, the current dividing unit consists of an active component and a passive component and includes any one of an inductor, a capacitor and a transistor.

Alternatively, the voltage dividing unit consists of an active component and a passive component and includes any one of an inductor, a capacitor and a transistor.

Preferably, the energy-saving device is electrically coupled between the output terminal of the electric power and the input terminal of the load in a built-in manner or in an externally connected manner.

The primary objective of the present invention is to provide an energy-saving device with a voltage-regulating function to save an electrical energy by dropping the voltage.

According to the primary advantage of the present invention, the voltage dividing unit regulates and drops the voltage of the load applied by the electric power, and the current dividing unit increases the current flowing into the load, so that the energy-saving device achieves an energy-saving purpose.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of an energy-saving device in accordance with the preferred embodiment of the present invention.

FIG. 2 is a circuit layout of the energy-saving device as shown in FIG. 1.

FIG. 3 is a schematic operational view of the energy-saving device in accordance with the preferred embodiment of the present invention.

FIG. 4 is a schematic operational view of the energy-saving device in accordance with the preferred embodiment of the present invention.

### DETAILED DESCRIPTION OF THE INVENTION

Referring to the drawings and initially to FIGS. 1 and 2, an energy-saving device 100 in accordance with the preferred embodiment of the present invention is electrically connected between an output terminal of an electric power S and an input terminal of a load L, and comprises a current dividing unit 1 connected with the load L in parallel, and a voltage dividing unit 2 connected with the load L serially.

The electric power S is an alternating-current input power supply.

The current dividing unit 1 has an input terminal electrically coupled to an output terminal of the load L and an output terminal electrically coupled to the input terminal of the load L.

The voltage dividing unit 2 has an input terminal electrically coupled to the output terminal of the electric power S and an output terminal electrically coupled to the input terminal of the load L.

In the preferred embodiment of the present invention, the energy-saving device 100 is electrically coupled between the output terminal of the electric power S and the input terminal of the load L in a built-in manner.

In another preferred embodiment of the present invention, the energy-saving device 100 is electrically coupled between the output terminal of the electric power S and the input terminal of the load L in an externally connected manner.

In the preferred embodiment of the present invention, the current dividing unit 1 is a passive component which is an inductor, and the voltage dividing unit 2 is a passive component which is an inductor.

In another preferred embodiment of the present invention, the current dividing unit 1 is a passive component which is a capacitor, and the voltage dividing unit 2 is a passive component which is a capacitor.

In another preferred embodiment of the present invention, the current dividing unit 1 is an active component which is a transistor, and the voltage dividing unit 2 is an active component which is a transistor.

In another preferred embodiment of the present invention, the current dividing unit 1 consists of an active component and a passive component and includes any one of an inductor, a capacitor and a transistor.

In another preferred embodiment of the present invention, the voltage dividing unit 2 consists of an active component and a passive component and includes any one of an inductor, a capacitor and a transistor.

As shown in FIG. 2, according to the Kirchhoff circuit law, the voltage VS of the electric power S is equal to the sum of the voltage V2 of the voltage dividing unit 2 and the voltage VL of the load L. In such a manner, the voltage dividing unit 2 and the load L share the voltage VS of the electric power S, so that the voltage dividing unit 2 reduces the voltage VL of the load L applied by the electric power S so as to achieve a voltage drop function. At the same time, the current iL flowing into the input terminal of the load L is equal to the sum of the current i1 flowing out of the current dividing unit 1 and the current i2 flowing out of the voltage dividing unit 2, so that the current iL flowing into the load L is not lost.

Accordingly, the voltage dividing unit 2 regulates and drops the voltage VL of the load L applied by the electric power S, and the current dividing unit 1 increases the current iL flowing into the load L, so that the energy-saving device 100 achieves an energy-saving purpose.

As shown in FIG. 3, the load L is available for an 3C electronic product (such as a notebook computer, tablet computer or cell phone), a household electric appliance, an experiment equipment, a medical equipment, a factory equipment and the like.

As shown in FIG. 4, the load L is available for an electric appliance (such as an electric pot), and the energy-saving device 100 is built in the load L directly, thereby saving the material of consumption, and thereby simplifying the construction.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An energy-saving device electrically connected between an output terminal of an electric power and an input terminal of a load, comprising:
a current dividing unit connected with the load in parallel; and
a voltage dividing unit connected with the load serially; wherein:
the current dividing unit has an input terminal electrically coupled to an output terminal of the load and an output terminal electrically coupled to the input terminal of the load; and
the voltage dividing unit has an input terminal electrically coupled to the output terminal of the electric power and an output terminal electrically coupled to the input terminal of the load.

2. The energy-saving device of claim 1, wherein the electric power is an alternating-current input power supply.

3. The energy-saving device of claim 1, wherein the current dividing unit is a passive component which is an inductor or a capacitor.

4. The energy-saving device of claim 1, wherein the voltage dividing unit is a passive component which is an inductor or a capacitor.

5. The energy-saving device of claim 1, wherein the current dividing unit is an active component which is a transistor.

6. The energy-saving device of claim 1, wherein the voltage dividing unit is an active component which is a transistor.

7. The energy-saving device of claim 1, wherein the current dividing unit consists of an active component and a passive component and includes any one of an inductor, a capacitor and a transistor.

8. The energy-saving device of claim 1, wherein the voltage dividing unit consists of an active component and a passive component and includes any one of an inductor, a capacitor and a transistor.

9. The energy-saving device of claim 1, wherein the energy-saving device is electrically coupled between the output terminal of the electric power and the input terminal of the load in a built-in manner or in an externally connected manner.
